(19) United States
(12) Patent Application Publication
(10) Pub. No.: US 2020/0270068 A1
(43) Pub. Date: Aug. 27, 2020

(54) ORIENTING SYSTEM FOR BEVERAGE CANS

(71) Applicant: Anheuser-Busch InBev S.A., Brussels (BE)

(72) Inventors: Robert GAAFAR, New York, NY (US); Maisie DEVINE, New York, NY (US); Patrick O'RIORDAN, New York, NY (US); Hilary FARNSWORTH, Hauppage, NY (US); Peter DAILY, Hauppage, NY (US); Doreen SWIFT, Hauppage, NY (US); Ralph CASSARA, Hauppage, NY (US); Joseph TORO, Hauppage, NY (US); Rodney MCGAUGH, Hauppage, NY (US)

(21) Appl. No.: 16/643,737

(22) PCT Filed: Aug. 31, 2018
(86) PCT No.: PCT/EP2018/073457

§ 371 Date: Mar. 2, 2020

(30) Foreign Application Priority Data
Sep. 1, 2017 (BE) BE2017-5613

(51) Int. Cl. B65G 47/252; B65G 1/08

(52) U.S. Cl. CPC B65G 47/252; B65G 1/08; B65G 2203/042; B65G 2203/0225; B65G 2201/0252

(57) ABSTRACT

The present disclosure provides an orienting system for orienting a beverage cans. The system includes a cradle for horizontally receiving a beverage can, mounted on a support frame. The cradle includes an open receiving portion extending towards and between a top end direction and a bottom end. The support frame is provided with a mechanism for enabling a tilting movement to the cradle supported thereon, thereby releasing the beverage can. The system further includes a sensing unit for sensing a top portion of the beverage can. Additionally, the system includes a control unit for receiving a sensing information from the sensing unit and accordingly provide a movement instruction to the support frame such that the beverage can is released in a top upright position.

### TECHNICAL FIELD

The present disclosure generally relates to an orienting system; and more particularly relates to an orienting system for orienting a horizontally received beverage can in a top upright vertical position.

### BACKGROUND

Containers, such as beverage cans, enclosing liquid foods such as for example, water, beer, beverages, etc. have lately been proved invaluable in a wide array of situations and is currently one of the most retailed product across the globe.

Many places, from industrial to civilian settings, for example in structures such as train stations, hospitals, schools, nightclubs, dance halls, restaurants and refreshment services of various type are equipped with one or more beverage serving stations at which a variety of canned beverages are maintained. Typically, such beverage cans are stocked in various kind of vending machines. These vending machines, by using various delivery mechanisms, in an appropriate manner, are capable of positioning the beverage cans at a delivery area, which may be accessible by the user for withdrawal thereof.

As stated above, these vending machines have been very successful in the marketplace with respect to achieving their objectives. However, all major currently known vending machines suffer from certain limitations. Most of these vending machines delivers the beverage can under the influence of gravity. Therefore the beverage cans are generally delivered in a random orientation and most of the times, fallen horizontally on the delivery plate.

Some vending machines which utilizes a dedicated delivery mechanism and deliver the beverage cans through a generally horizontal delivery channel in a horizontal orientation. However, in the current world of automation, the user might not want to make efforts for orienting the can and may simply want to pick up and open the cans while performing other tasks.

Various mechanisms have been developed for providing the functionality of vertically orienting the beverage cans at the delivery area. One such mechanism is disclosed in US Publication 3710978. Such mechanism generally include introduction of the beverage cans within the storage compartment of the vending machine in a vertical orientation. Such a requirement is not preferred as it slows down the process of filling the storage compartment. Further, support mechanism have to be utilized in such an arrangement so as to keep the cans stable, thereby making the internal structure of machine, complex and expensive and is not therefore preferred. Some other vending machines included a gripper for picking up a can and delivering it to the delivery area in a vertical orientation.

However, none of the above disclosed machines deliver the beverage cans in top upright direction. The can delivered still requires to be oriented before they can be opened and drunk. Also, prior art tools are not technically compatible for being implemented in beverage can vending machines that would enable the delivery of properly oriented beverage cans.

As can be seen from the foregoing discussion, there still exists a need for an improved can orienting system which while being easy to use, and cost-effective, may also be utilized within vending machines, in particular vending machines delivering top upright oriented beverage cans, without requiring changes to present can designs.

### SUMMARY

In one aspect of the present disclosure, an orienting system for orienting a beverage cans is provided. The system includes a cradle for horizontally receiving a beverage can, mounted on a support frame. The cradle includes an open receiving portion extending towards and between a top end at a proximal direction and a bottom end at a distal direction. The support frame is provided with a mechanism for enabling a tilting movement to the cradle supported thereon, thereby releasing the beverage can. The system further includes a sensing unit for sensing a top portion of the beverage can. Additionally, the system includes a control unit for receiving a sensing information from the sensing unit and accordingly provide a movement instruction to the support frame such that the beverage can is released in a top upright position.

Possibly, the support frame is further capable of providing a rotational movement to the cradle.

Generally, the movement instruction includes a tilting movement instruction for tilting the end of the cradle corresponding to the top portion of the beverage in an upward direction.

Potentially, the system includes a drop platform besides one of the top end/bottom end of the cradle such that the beverage can is released from the cradle to be placed onto the drop platform.

Optionally, the movement instruction further includes a rotating movement before the tilting movement.

Optionally, the support frame includes an automatic movement means for providing a rotational and/or tilting movement to the cradle.

Further optionally, the automatic movement means may be selected from one or more of but not limited to an electrical piston, electric gear, electric motor, or the like.

For sensing a top portion of the beverage can, the sensing unit may include an optical sensor and an optical trigger unit for triggering the sensor, or may include a mechanically sensing system.

Additionally, the system includes a functional attachment means for attaching to an external system selected from but not limited to various kind of vending machines, or the like.

Further, in such instances, the system includes a physical attachment means for mounting the system onto the external system.

Possibly, the functional attachment means may be selected from but not limited to one of USB cable, serial data cables, and the like.

Further possibly, the physical attachment means may be selected from but not limited to a mounting bracket, hinged mounting, and any other suitable mounting mechanism known in the art.

Preferably, the receiving portion of the cradle is a generally concave shaped center portion extended towards sidewalls on both sides.

Further preferably, the receiving portion of the cradle has a diameter more than a diameter of the beverage can.

In another aspect of the invention, a method for orienting a beverage can is disclosed. The method include receiving a beverage can horizontally onto the receiving portion of the cradle. The method further includes receiving one or more movement instructions at the support frame from the control unit, for releasing the beverage can in a top upright orientation.

Possibly, the control unit receives a sensing information from the sensing unit to generate the one or more movement instructions.

In yet another aspect of the present disclosure, a vending machine employing the orienting system of the current invention is disclosed.

The details of one or more implementations are set forth in the accompanying drawings and the description below. Other aspects, features and advantages of the subject matter disclosed herein will be apparent from the description, the drawings, and the claims.

### BRIEF DESCRIPTION OF THE DRAWINGS

FIG. 1 is a block diagram representing an orienting system, in accordance with an embodiment of the present disclosure;

FIG. 2a is a schematic view of the orienting system of FIG. 1, in accordance with an embodiment of the present disclosure;

FIG. 2b is a perspective view of a support bracket, in accordance with an embodiment of the present disclosure;

FIG. 3 is a perspective view of the cradle, in accordance with an embodiment of the present disclosure;

FIG. 4 is a schematic view of an orienting system, in accordance with a preferred embodiment of the present disclosure;

FIG. 6 depicts a flowchart illustrating the steps for orienting a beverage can, in accordance with an embodiment of the present disclosure; and

FIG. 5 depicts a vending machine employing an orienting tool, in accordance with an embodiment of the present disclosure;

### DETAILED DESCRIPTION

As required, a schematic, exemplary-only embodiment of the present application is disclosed herein; however, it is to be understood that the disclosed embodiment is merely exemplary of the present disclosure, which may be embodied in various and/or alternative forms. Specific structural and functional details disclosed herein are not to be interpreted as limiting, but merely as a basis for the claims and as a representative basis for teaching one skilled in the art to variously employ the present disclosure in virtually any appropriately detailed structure.

Aspects, advantages and/or other features of the exemplary embodiment of the disclosure will become apparent in view of the following detailed description, which discloses various non-limiting embodiments of the invention. In describing exemplary embodiments, specific terminology is employed for the sake of clarity. However, the embodiments are not intended to be limited to this specific terminology. It is to be understood that each specific portion includes all technical equivalents that operate in a similar manner to accomplish a similar purpose.

Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures.

The present application discloses an orienting system for use in orienting beverage cans enclosing liquids such as cold drinks, beer, wines, mineral water etc in a ready to be opened state i.e. oriented in a top upright position which can be picked up and opened by a consumer. The system may generally be used for orienting any kind of beverage cans, irrespective of carbonation level, alcohol level, viscosity level, for example in company restaurants, school canteens, etc. It should be understood that embodiments of the present invention may be applied in combination with various type of beverage cans irrespective of size, shape and materials, used in the beverage industry. It must also be noted that, as used in this specification and the appended claims, the singular forms “a,” “an” and “the” include plural referents unless the context clearly dictates otherwise. Thus, for example, the term “an opening” is intended to mean a single opening or a combination of openings, “a driving means” is intended to mean one or more driving means, or a combination thereof.

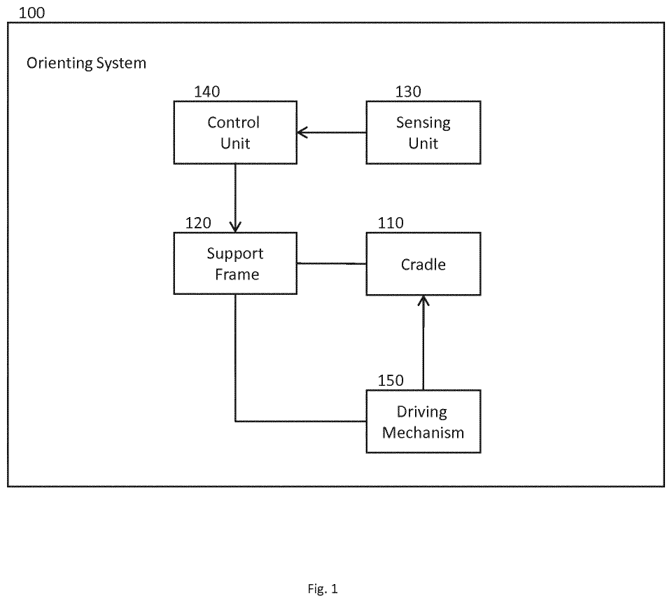

FIG. 1 depicts a block diagram displaying basic components of the system of the present disclosure. As illustrated in FIG. 1, the present disclosure provides an orienting system 100 for orienting a beverage can [not shown]. The system 100 comprises a cradle 110 for receiving a beverage can, generally in a random horizontal orientation. The system 100 further includes a support frame 120 for holding the cradle. The support frame 120 includes a driving mechanism 150 adapted to provide a tilting movement and optionally, a rotating movement to the cradle 110 supported thereon. The system 100 furthermore includes a sensing unit 130 for sensing an orientation of the beverage can placed onto the cradle 110. Moreover the system 100 includes a control unit 140 connected to the sensing unit 130, and to the support frame 120 of the for providing one or more movement instructions to the support frame 120. In operation, the control unit receives a sensing information from the sensing unit and sends one or more movement instructions for the driving mechanism 150 of the support frame 120.

FIG. 1 schematically show the arrangement of the basic components of the vending machine 100 of the present disclosure. However, in the construction of commercial functional units, secondary components such as wires, leads, couplers, connectors, support structure and other functional components known to one of skill in the field of thermodynamics and more particularly the vending machine technology may be incorporated within the orienting system 100. Such commercial arrangements are included in the present invention as long as the structural components and arrangements disclosed herein are present.

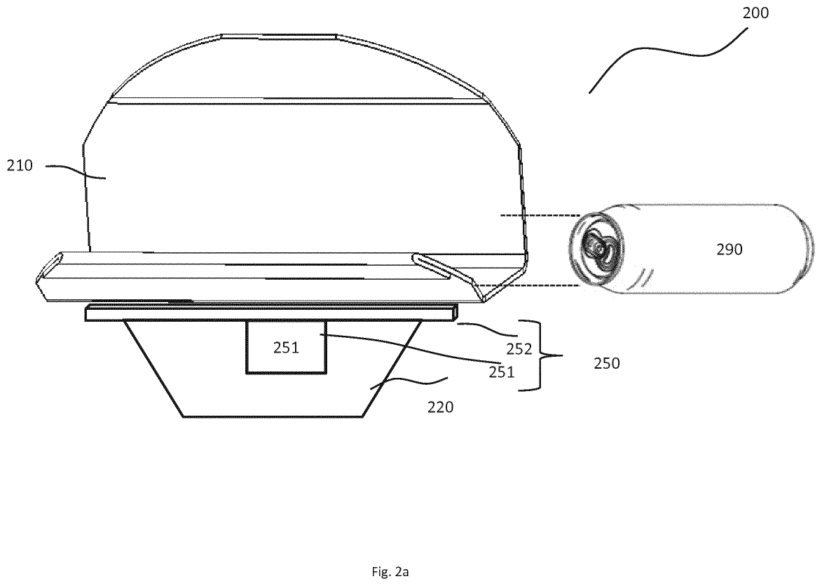

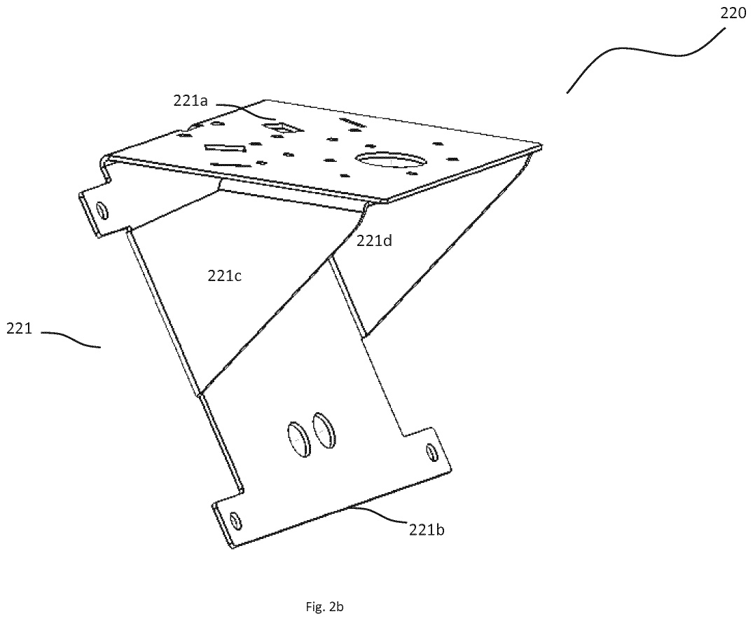

Referring to FIG. 2a, a orienting system 200, generally represented by a numeral 200 for orienting a generally cylindrical shaped beverage can 290 having a top surface 291 and a bottom surface 292, is illustrated in accordance with an embodiment of the present disclosure. While the shape of the beverage can 290 is cylindrical for exemplary purpose only, it should be understood that the beverage can 290 may be of any shape and size, including the radius and height suitable for enclosing its contents. Further, the shape and size, including the radius and height of the orienting system 200 may be varied depending on the design constraints and requirements for its application, as will be discussed later.

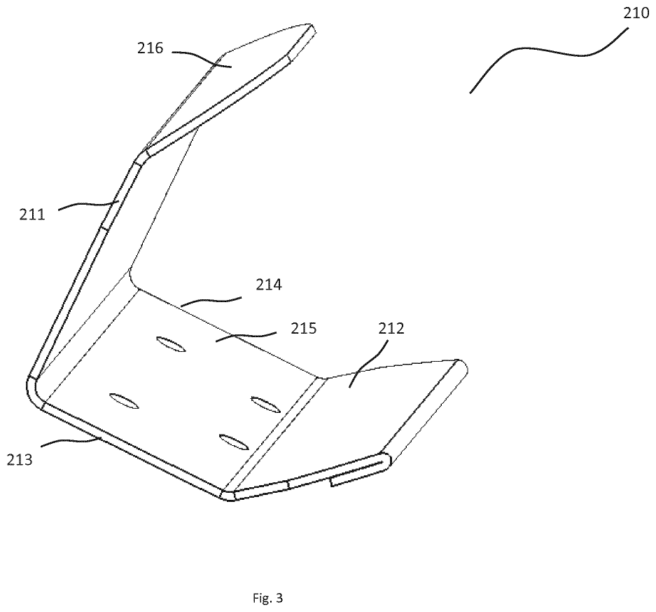

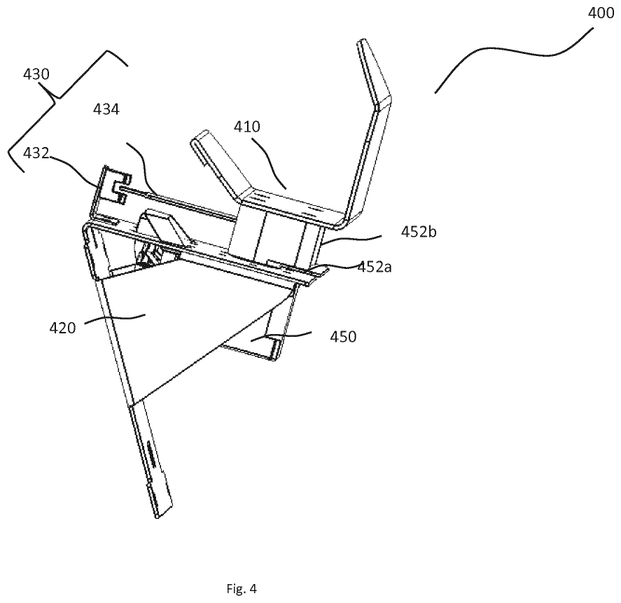

The orienting system 200 includes a cradle 210 [as illustrated in FIG. 3] having a generally open quadrilateral shape having an open receiving portion 215 for horizontally receiving the beverage can 290. The receiving portion 215 is generally extended towards and between a first sidewall 211, a second sidewall 212, an open top end 213 and an open bottom end 214. The first sidewall 211 and the second sidewall 212 are generally shaped to allow a comfortable release of the beverage can 290 through the open ends 213, 214 of the cradle 210. The first sidewall 211 may include a lip portion 216 extending over the open receiving portion 215 to avoid the possibility of a free fall of the beverage can 290 during the release thereof.

In some embodiments of the present invention, the receiving portion 215, may be of a generally concave shape for comfortably receiving the beverage can 290. In such embodiments, a diameter of the receiving portion 215 is greater than a diameter of the beverage can 290.

The orienting system 200 further includes a support frame 220 for securely and movably holding the cradle 210 in a through one or more connection mechanism such as screw based attachment screw, or any other suitable mechanism known in the art. The support frame 220 includes a generally closed housing 221 having a top surface 221a, bottom surface 221b and four lateral sides 221c defining an interior portion 221d therein. In some embodiments, as illustrated in FIG. 2b, the support housing 221 may be in form of a support bracket 221 having a top surface 221a.

The housing 221 includes a driving mechanism 250 placed therein. The driving mechanism 250 includes a driving means 251, and one or more cradle driving components 252 extending out of the housing 221 through one or more openings [not shown] within the top surface 221. The cradle driving components 252, therefore is connected to the driving means 251 at one end and to the cradle 210, at the other end.

The driving mechanism 250, the driving means 251, and the cradle driving component 252 may be selected from any combination known in the art, suitable for selectively providing a movement such as tilting movement, rotational movement, lifting movement, and the like, to the cradle 210 placed onto the support frame 220. For example, in some embodiments, the driving means 251 may be an electric motor and the cradle driving component 252 may be one or more shaft for providing movement to the cradle 210. Further, in such embodiments, the cradle driving component 252 may be selected as a combination of various possible components, such as dry bearing, shaft belts, and lifting and/rotating rods, magnet bars, and the like. The driving mechanism 250, in such embodiments, may be able to operate in different modes such as for example, providing a tilting movement in one mode, a rotational movement in a second mode, and a lifting movement in third mode, and the like.

The orienting system 200 further includes sensing unit having one or more sensors (not shown) for sensing the orientation of the beverage can 290 so as to detect top surface 291 thereof. The one or more sensors, generally detects the top surface 291 on the basis of a differences in a depth of the top surface 291 and the bottom surface 292. The sensing unit may include any combination of sensors, and related components, known in the art and suitable for detecting the top surface 291 of the beverage can 290. In some embodiments, the sensing unit includes one or more optical sensor and corresponding optical trigger unit. In such embodiments, when triggered by the optical trigger unit, the optical sensor senses the depth present at both the end surfaces of the beverage can 290 to detect the top surface 291. In some other embodiments, the sensing unit comprises one or more touch sensors, which mechanically and physically connects the end surfaces of the beverage cans 290 to detect the top surface 291 thereof. For example, the difference between the depth of the top and bottom surface may be determined by the degree of compression of a resilient material engaging on each of these surfaces.

The orienting system 200 of the present disclosure may further include a control unit [140] for managing the operations of the orienting system as illustrated in FIG. 1. It may be understood that the control unit 140 may be a computing device, including typical components like, a display unit, a central processing unit (CPU), random access memory (RAM), read-only memory (ROM), at least one stored program, display readouts, and at least one input unit. The control unit 140 is connected to the sensing unit, and the support frame 220 at its driving mechanism 250. In general, the control unit 140 is adapted to receive operational inputs from the sensing unit and provide movement instruction to the driving mechanism 250. In some embodiments, the control unit 140 is connected to the driving mechanism 250 through one or more automatic relay switches [not shown], each relay adapted to provide a specific kind of movement to the cradle 210 through the cradle driving component 252. For example, a first relay switch is for providing the tiltling movement to the cradle 210, a second relay switch is adapted to provide a rotational movement to the cradle 210, and a third relay switch is adapted to provide a lifting movement to the cradle 210, and so on. In such embodiments, on receiving the sensing information from the sensing unit, the processing unit of control unit 140 determines the kind of movement required in order to release the can 290 in the top upright orientation and accordingly sends the movement instruction to the driving mechanism 250 of the support frame 220.

The CPU, RAM, ROM, and program act in concert to evaluate the inputs received and to control the cooling process. The CPU and RAM may be specially manufactured for this invention, or may preferably make us of off-the-shelf items available at the time of manufacture. The ROM may also be specially designed for this invention and may include program instructions. However, PROMs, EPROMs, EEPROMs or the like are preferred, which allow for selective programming, and may be arranged to be programmed even in the field. The RAM is preferably used to temporarily store operator and system inputs, but may also be used to store programming instructions supplemental to the program or programs stored in the ROM. Based on the programming instructions from the ROM or other memory source and the inputs received, the CPU sends outputs to the display panel, as well as to outputs that control various components of the system 200.

The orienting system 200 further includes a powering unit [not shown] for providing an electric current to the various components thereof. The powering unit 140 generally connects to the control unit 140, the sensing unit, and to the driving mechanism 250 to provide power to various components such as driving means 252, cradle driving means 251, sensors, display units, input units, and other sub-components thereof.

The powering unit may be connected to an electric socket through a power cord [not shown]. Alternatively, the power cord may terminate in a connector such as a male plug, a female plug, alligator clips, a banana plug, battery connectors, battery adapters, current adapters and other similar devices to connect the orienting system 200 to a mobile power source. The mobile power source may be one of but not limited to a portable battery, solar panel, generator, etc. In some embodiments the powering unit may include an additional integrated power source, such as alkaline batteries, or a rechargeable battery such as a lithium ion or a nickel cadmium battery, or the like. The power source may be removable and/or replaceable within the powering unit.

In some embodiments, the orienting system 200 may include one or more functional attachment means [not shown] for connecting the system onto the external system, such as a vending machine, and the like. Examples of the functional attachment means include but not limited to USB cable, Serial Data Cable, and the like.

Further, the orienting system 200 may include one or more physical attachment means [not shown] for connecting the system 200 onto the external system, such as to components of the vending machine, attachment surfaces, and the like. Examples of the physical attachment means include but not limited to mounting bracket, hinged attachment, and the like.

Preferably, the cradle 210 and the housing 222 of the support frame 220 may be made of a material selected from one of but not limited to thermoset polymers that exhibits desirable wear and acceptable formability characteristics. The preferred thermoset polymers may be selected from one of but not limited to the group consisting of polyoxymethylene (POM), Acrylonitrile butadiene styrene (ABS), Nylon 6, Nylon 6-6, Polyamides (PA), Polybutylene terephthalate (PBT), Polycarbonates (PC), Polyetheretherketone (PEEK), Polyetherketone (PEK), Polyethylene terephthalate, (PET), Polyimides, Polyphenylene sulfide (PPS), Polyphenylene oxide (PPO), Polysulphone (PSU), and Polytetrafluoroethylene (PTFE/Teflon).

Alternatively, the cradle 210 and the housing 222 of the support frame 220 may be made of a hard material such as a steel with a coating of a material selected but not limited to thermoset polymers such as polyoxymethylene (POM), Acrylonitrile butadiene styrene (ABS), Nylon 6, Nylon 6-6, Polyamides (PA), Polybutylene terephthalate (PBT), Polycarbonates (PC), Polyetheretherketone (PEEK), Polyetherketone (PEK), Polyethylene terephthalate, (PET), Polyimides, Polyphenylene sulfide (PPS), Polyphenylene oxide (PPO), Polysulphone (PSU), and Polytetrafluoroethylene (PTFE/Teflon) or thermoset resins such as selected from group consisting of but not limited to selected from a group consisting of: Polyurea, Bis-maleimides, Epoxy, Phenolic, Melamine formaldehyde, Polyester, Polymide, Polyurethane, Urea-formaldehyde, Epoxy and Novolac

In some embodiments, the orienting system includes a drop platform [not shown] adapted to receive the oriented beverage can 290 placed in a release direction [a direction distal/proximal to the cradle]. In such instances, the control unit 140 may be configured to provide the movement instructions to the driving mechanism 250 such that the beverage can 290 is released in the direction of the drop platform in the top upright position. Accordingly, in such instances, at the time of release, the top surface 291 of the beverage can 290 is always present at the end of cradle 210 opposite to the end at the release direction. Therefore, if the sensing unit senses that the top surface 291 of can 290 is directed towards the release direction, the control unit 140 instructs the driving mechanism 250 to rotate the cradle 210 at an angle 180 degree thereby moving the top surface 291 to the end opposite the release direction. Thereafter, the control unit 140 instructs the driving mechanism 250 to provide a tilting movement such that the end of the cradle opposite to the release direction is moved up thereby releasing the beverage can 290 onto the drop platform in the top upright orientation.

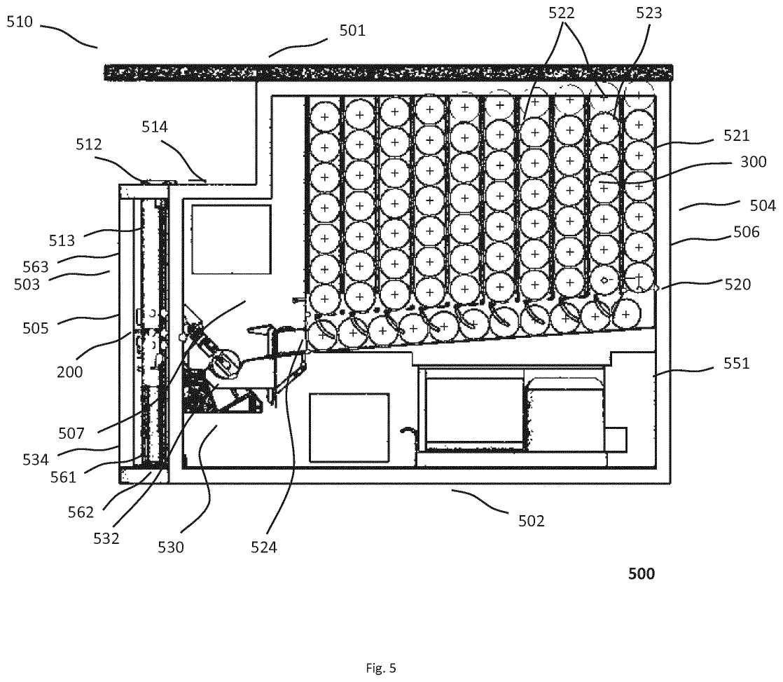

FIG. 4 illustrates an exemplary orienting system 400 that may be used to suitably detect and change the orientation of the beverage can 290. The orienting system 400 includes a top receiving portion 410 supported onto a support bracket 420. The system further includes a sensing unit 430 having an optical sensor 432 and optical triggering unit 434. The system further includes a control unit [not shown] connected to the sensing unit 430, and to a driving mechanism 450 through one or more switches 460. The drive mechanism 450 includes an electric motor 451 used as a driving means and a combination of a dry bearing 452a and a bar magnet 452b, used as a cradle driving means. Further, the system 400 includes various commercial functional units, secondary components such as wires, leads, couplers, connectors, support structure and other functional components known to one of skill in the field of thermodynamics and more particularly the vending machine technology.

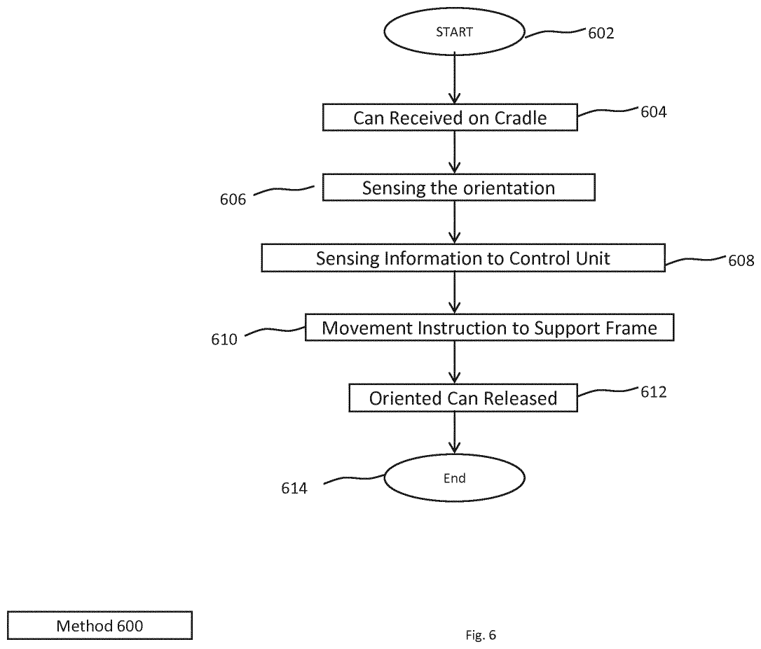

FIG. 6 with reference to FIGS. 1 through 4, is a flow diagram illustrating a method 600 of orienting a beverage can 290, using the orienting system 200 of the present disclosure. The method starts at step 602 and proceeds to step 604 where a beverage can 290 is received onto the cradle 210 of the orienting system 200. The beverage can 290 may be received from any attached system, such as for example, a vending machine, or from any delivery channel delivering the beverage cans in a random horizontal orientation. Thereafter, the method 600 proceeds to step 606 where the sensing unit senses the orientation of the beverage can 290 to detect the top surface 291 thereof. At step 608, the sensing unit sends the sensing information to the control unit 140 which in turn sends a movement instruction to the driving mechanism 250 of the support frame 220 at step 510. Generally, the movement instructions include a tilting movement by lifting the end of the cradle 210, present in the direction of the top surface 291 of the beverage can 290, as detected by the sensing unit. However, in the embodiments, which include the drop platform for receiving the oriented beverage can 290, at the time of release, the top surface 291 of the beverage can 290 is always present at the end of cradle 210 opposite to the direction of the release direction. Therefore, if the top surface 291 of can 290 is directed towards the release direction, the control unit 140 instructs the driving mechanism 250 to rotate the cradle 210 at an angle 180 degree thereby moving the top surface 291 to the end opposite the release direction. Thereafter, the control unit instructs the driving mechanism 250 to provide a tilting movement such that the end opposite to the release direction is moved up thereby releasing the beverage can 290 at step 512, onto the drop platform in the top upright orientation

### INDUSTRIAL APPLICABILITY

The present disclosure relates to orienting system 200 for orienting a beverage cans enclosing liquids, such as beer, wine, cider, hard liquor (e.g., distilled beverage, spirit, liquor, hard alcohol, etc.), soft drinks (e.g., cola, soda, pop, tonic, seltzer), iced tea, soda water and other types of carbonated/non-carbonated beverages. The orienting system 200 while being cost-efficient and portable, is very quick and easy to be operated by end consumers, or by the retailers in various shops, bars etc for orienting beverage cans of any shape, size or any variety of configurations, in a ready to be opened state.

As should be appreciated, the realization of such orienting system allows the end consumer to safely pick up and quickly open the beverage cans. While the orienting system of current disclosure may function as an independent self-sustaining unit, it may also be integrated with various vending machines known in the art, thereby providing the consumer with a ready to be opened beverage cans out of the vending machine.

FIG. 5 illustrates an exemplary vending machine 500 employing the orienting system of the current disclosure. The vending machine 500 includes a main housing 510 having a generally quadrilateral shape having a top portion 501, bottom portion 502, front portion 503 and a back portion 504 extending between a first side 505 and a second side 506 defining an interior space 507 within the main housing 510. The main housing 510 includes a delivery slot 512 and a payment interface 514 configured onto a top portion 501 thereof.

The delivery slot 512 is generally an opening slot into the main housing 510 connected to a tubular structure 513 extending into the interior space 507 of the main housing 510 and adapted to receive the beverage can 300 stored within the vending machine 500. The payment interface 514 is an interface configured to accept payment using a plurality of known mechanism

The interior portion 507 of the main housing 510 includes a refrigerant compartment 520 for storing the beverage cans 300 in a cooled state and a delivery sub-system 530 for delivering the beverage can 300 from the refrigerant compartment 520 to the delivery slot 512 through the tubular structure 513.

The refrigerant compartment 520 includes a top compartment 521 for storing the plurality of beverage cans 300 partitioned from a base refrigerant unit 551 through a generally declining plate 552 extending towards a refrigerant door 553 of the refrigerant compartment 520. The base refrigerant unit 551 may be any conventionally known refrigerant unit known in the art, and suitable to be used with the vending machines.

The top compartment includes a plurality of columns 522, each capable of storing a stack 523 of beverage cans 300, and having a release door 524 at a lower portion CI thereof. The compartment 521 further includes a motor assembly (290) for releasing (opening)/locking (closing) the release door 524.

The refrigerant compartment 220 further includes a door opening mechanism 554 for opening the door 553 such that only one beverage can 300 may be dispensed out of the refrigerant compartment towards the delivery sub-system 530 at a receiving station 532 thereof.

The delivery sub-system 530 as disclosed earlier receives the beverage can 300 at the receiving station 532. The receiving station 532 is generally a trough shaped open case having a diameter adapted to comfortably receive the beverage can 300.

The delivery sub-system 530 further includes an elevator station 534 adapted to deliver the beverage can 300 received at the receiving station 532. The elevator station 534 is further adapted to deliver the beverage can 300 to the delivery slot 512. The elevator station 534 includes a base elevator platform 561 rigidly attached to an elevator back plate 562, and an elevator shaft 563 connected to the delivery slot 512 through the tubular structure 513. The elevator platform 561 is adapted to receive the beverage can 300 and deliver it to the delivery slot 512 thereby making the can 300 accessible to the consumer.

The elevator station 534 may be functionally connected to the receiving station 532 through an orienting station 536. The orienting station 536 receives the beverage can 300 from the receiving station 532, orients and places it onto the elevator platform 561 in a top upright direction. The delivery sub-system 530 further include a transfer mechanism 539 for transferring the beverage can 300 from the receiving station 532. The transferring mechanism 539 may be any suitably known transfer mechanism known in the art.

The orienting station may be any known mechanism that may be used to suitably detect and change the orientation of the beverage can 300. In one preferred embodiments of the present invention, the orientation station 536 includes the orienting system 400 as mentioned in FIG. 4 of the current disclosure.

The delivery sub-system further includes an opening mechanism 580 for opening the beverage can 300 received onto the platform 561 while being delivered from the base position B1 towards the top position T1. The opening mechanism 580 may be any known suitable mechanism known for opening the tab 592 of the beverage cans 290. In a preferred embodiment as illustrated in FIG. 5, the opening mechanism 580 includes a tab-orienting mechanism 581 for orienting the tab 592 of the can 590 placed onto the elevator platform 561 in a predetermined direction. The opening mechanism 580 further includes one or more opener portion 582 to pull-open the oriented tabs 302 while the platform 261 is moving vertically upwards to deliver the can 300 onto the delivery slot 512.

The vending machine 500 may further include a control unit [not shown] for managing the operations of the vending machine 500 It may be understood that the control unit 140 may be a computing device, including typical components like, a display unit, a central processing unit (CPU), random access memory (RAM), read-only memory (ROM), at least one stored program, display readouts, and at least one input unit. The control unit is connected to a and refrigerant compartment 520 and delivery sub-system 530 of the vending machine 500.

The vending machine 500 further includes a powering unit [not shown] for providing an electric current to the various components thereof. The powering unit generally connects to the control unit, the refrigerant unit 520 and the delivery sub-system 530 to provide power to various components such as motors, sensors, display units, input units, and other sub-components thereof.

In operation, when the vending machine 500 receives a beverage can 300 dispensing request from a consumer, the control unit sends an instruction to the refrigerant compartment 520 and the delivery sub-system 530 for dispensing the beverage can 300. In response to the instruction received from the control unit, the refrigerant compartment 520 releases a can 300 which is dispensed from the top compartment 551 into the receiving station 532 of the delivery sub-system 530 which is then first oriented at the orientation station 536 and placed onto the elevator platform 561 which is vertically moved towards the delivery slot 512, where on the way, the claw tip 226 of the opening tool 200 engages and pulls the tab 314, thereby opening the beverage can 300. Thereafter, the elevator platform 561 moves through the tubular structure 513 and is parked onto the delivery slot 512, thereby making the opened beverage can 300 accessible to the consumer.

While the orientation system 200 is described for orienting beverage cans having a generally cylindrical shape, it is also contemplated for a person skilled in the art that the orientation system 200 may be used to open beverage cans of the type comprising a hollow container body having various shapes such as a rectangular cross-section, or the like.

Referring to FIG. 6, methodology in accordance with a preferred embodiment of the claimed subject matter is illustrated. While, for purposes of simplicity of explanation, the methodology is shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Throughout the specifications of the present disclosure, the term “comprising” means including but not necessarily to the exclusion of other elements or steps. In other words, the term comprising indicates an open list. Furthermore, all directional references (such as, but not limited to, upper, lower, inner, outer, upward, downward, inwards, outwards, right, left, rightward, leftward, inside, outside, top, bottom, above, below, vertical, horizontal, clockwise, and counter-clockwise, lineal, axial and/or radial, or any other directional and/or similar references) are only used for identification purposes to aid the reader's understanding of illustrative embodiments of the present disclosure, and may not create any limitations, particularly as to the position, orientation, or use unless specifically set forth in the claims. Moreover, all directional references are approximate and should not be interpreted as exact, but rather as describing a general indicator as to an approximate attitude.

Similarly, joinder references (such as, but not limited to, attached, coupled, connected, accommodated, and the like and their derivatives) are to be construed broadly and may include intermediate members between a connection of segments and relative movement between segments. As such, joinder references may not necessarily infer that two segments are directly connected and in fixed relation to each other.

In some instances, components are described with reference to “ends” having a particular characteristic and/or being connected with an-other part. However, those skilled in the art will recognize that the present disclosure is not limited to components which terminate immediately be-yond their points of connection with other parts. Thus, the term “end” should be interpreted broadly, in a manner that includes areas adjacent, rearward, forward of, or otherwise near the terminus of a particular segment, link, component, part, member or the like. Additionally, all numerical terms, such as, but not limited to, “second”, “second”, “third”, “fourth”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

1. A system for orienting a beverage can, the system comprising:
a cradle for receiving a beverage can, the cradle comprising an open receiving portion extending between a top end and a bottom end;
a sensing unit for sensing a top surface of the beverage can received onto the cradle;
a support frame for holding the cradle, the support frame capable of providing a tilting movement to the cradle;
a control unit adapted to receive a sensing information from the sensor and accordingly provide a movement instruction to the support frame;
wherein when a beverage can is received onto the cradle, the control unit sends the movement instruction to the support frame so as to release the beverage can in a top upright position.

2. The system of claim 1, wherein the movement instruction comprising a tilting instruction for tilting the end of the cradle corresponding to the top surface of the beverage can in an upward direction.

3. The system of claim 1, wherein the support frame is further capable of providing a rotational movement to the cradle.

4. The system of claim 1, further comprising a drop platform towards a releasing end of the cradle such that when the beverage can is released from the cradle, it the beverage can gets placed onto the drop platform.

5. The system of claim 2, wherein the movement instruction comprises a rotation instruction such that a top portion of the can is moved to an end away from the drop platform wherein further, the tilting instruction comprises tilting the end away from the drop platform in an upward direction.

6. The system of claim 1, wherein the support frame comprises driving means for providing a rotational and/or tilting movement to the cradle.

7. The system of claim 6, wherein the driving means is chosen from an electrical piston, gear, and electric motor.

8. The system of claim 1, wherein the system comprises a functional attachment means for attaching to an external system.

9. The system of claim 1, wherein the receiving portion is a generally concave open base portion having a diameter more than the diameter of the beverage can.

10. A beverage can vending machine comprising a system according to claim 1.

11. A method for orienting a beverage can using the system of claim 1, the method comprising the step of:
receiving the beverage can onto the receiving portion of the cradle;
obtaining the movement instructions from the control unit thereby releasing the beverage can in a top upright direction.

12. The method of claim 11, wherein the step of obtaining movement instruction comprises receiving a sensing information from the sensing unit.

13. The method of claim 11, wherein the beverage can is released onto the drop platform.

14. The system of claim 8, wherein the external system is a vending machine.
